(19) United States
(12) Patent Application Publication
(10) Pub. No.: US 2010/0067247 A1
(43) Pub. Date: Mar. 18, 2010

(54) SHIELD DEVICE

(76) Inventors: Frank Auer, Herbrechtingen-Bolheim (DE); Gerhard Behr, Altheim (DE); Peter Helbig, Sontheim/Brenz (DE); Christian Seichter, Herbrechtingen (DE); Klaus Wittmann, Sontheim (DE); Sascha Zelt, Beimerstetten (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/312,733

(22) PCT Filed: Dec. 12, 2007
(86) PCT No.: PCT/EP2007/063767

§ 371 Date: May 22, 2009

(30) Foreign Application Priority Data
Dec. 21, 2006 (DE) 102006060772.4

(51) Int. Cl. F21V 19/00; F21V 7/00; B60Q 1/04

(52) U.S. Cl. 362/519; 362/516; 362/539

(57) ABSTRACT

The invention relates to a shield device for a headlamp, said device having a reflector with an opening that has a diameter of less than 38.2 mm and two luminous bodies. The shield device is designed in such a way that at least one boundary of the sector shielded by the shield device on the reflector in the vicinity of the opening, said sector lying on a straight line between the reflector opening and a circle around the reflector opening with a diameter of 38.2 mm, when viewed on a plane running parallel to the reflector opening.

### TECHNICAL FIELD

The invention proceeds from a shield device for a headlight lamp.

### PRIOR ART

Document DE 19624688A1 discloses a shield device for a motor vehicle headlight lamp having an anti-dazzle device for one of the two filaments of a two-filament halogen incandescent lamp. Formed in a fashion opposing a welding lug, pointing toward the lamp bowl, on the anti-dazzle device is a shielding nose which shields the passing beam incandescent filament and the high beam incandescent filament from one another. This publication reveals nothing relating to a desired configuration of the boundary of the shielded sector formed on the inner surface of the reflector.

Details on the configuration of an H4 halogen incandescent lamp are known from Regulation ECE 37. This halogen incandescent lamp has an incandescent filament near the base, and an incandescent filament remote from the base that has an anti-dazzle device. The anti-dazzle device serves in this case to provide the light/dark boundary in the case of the passing beam. The diameter of the reflector cutout must be 38.2 mm because of the base configuration of the H4 halogen incandescent lamp.

The design requirements in the motor vehicle sector are currently leading to ever smaller headlights that constitute new challenges for the designers of such headlight lamps.

### SUMMARY OF THE INVENTION

The object of the present invention is to provide a shield device for a headlight lamp by means of which efficient use of the reflector surface by the illuminants of a halogen incandescent lamp is possible even given diameters of the reflector cutouts that are below 38.2 mm.

This object is achieved by a shield device for a headlight lamp as claimed in claim 1, and by a shield device having a reflector and two illuminants as claimed in claim 9.

Particularly advantageous refinements are to be found in the dependent claims.

A shield device for a headlight lamp is provided that has a reflector and two illuminants. The reflector has a reflector cutout of smaller diameter than 38.2 mm. The shield device is configured in such a way that, when viewed from a plane parallel to the reflector cutout, at least one boundary of the sector, which is near the cutout, shielded by the shield device on the reflector, and located between the reflector cutout and a circumscribed circle about the reflector cutout with a diameter of 38.2 mm, lies on a straight line. As a result, the shield device can effect a shielding with reference to one of the illuminants, while the shielded sector of the reflector for the emission behavior of the second illuminant can be optimized. More useful light can thereby be obtained from the second illuminant.

Furthermore, it is preferred that, when viewed from a plane parallel to the reflector cutout, a boundary of that shielded sector that is located between the reflector cutout and the outer circumference of the reflector lies on a straight line. It is thereby possible to optimize the region in which the reflector for the illuminant not provided with the shield device is reflected.

When both boundaries of the shielded sector lie on a straight line, the reflector for the non-shielded illuminant can be optimized. It is preferable furthermore, that the straight line of the boundaries cuts the center of the reflector cutout so as to provide a symmetry of the configuration of the shielded sector, and thus to optimize the configuration of the illumination. It is preferred, furthermore, that the straight line cuts the center of the reflector cutout. This results in a radial extent of the boundary of the shielded sector, and thus in fabrication advantages for the shielded sector of the reflector with reference to the illuminant that illuminates this shielded sector.

In an inventive development, the shielded sector lies in an angle range of substantially 120° to 165°. It is thereby possible for the two functions of the headlight lamp such as, for example, daylight running light and high beam to be implemented while making effective use of the light of the illuminants.

It is preferred, furthermore, that the shield device has a shielding nose whose edges form the boundary for the shielded sector. An accurate course of the boundaries of the shielded sector can thereby be implemented by an accurate edge configuration.

In a development, a location inside the reflector cutout is configured such that it can be shielded by the vertex edge of the shielding nose. It is possible in this way to avoid further scattered light in the base region of the headlight lamp.

The greatest width of the shield device is in the range from approximately 5 mm up to approximately 12 mm. It is thereby possible to undertake an effective configuration of the headlight lamp in conjunction with the small size of the lamp vessel and a good light yield.

Furthermore, a shield device as described above is provided, having a reflector and two illuminants arranged in the reflector interior. In this case, the configuration of the shield device is optimized in relation to the relative arrangement of reflector, illuminant and shield device.

It is preferred that the shield device is arranged in such a way that said shield device does not effect any shielding of the reflector with reference to an illuminant provided in the reflector. Thus the entire reflector inner surface is available for illumination by this illuminant, and can be optimized with reference to the latter.

The diameter of the reflector cutout is preferably in the region from 10 mm to less then 38.2 mm, such that headlights are possible that have a high light yield and are smaller than those with the halogen incandescent lamp H4, for example.

In a development, two illuminants are respectively illuminants that are near the base and remote from the base and which can be shielded from one another by a shielding nose of the shield device. Consequently, no scattered light occurs between the illuminants, and the illuminant near the base can have the function of a high beam, by way of example.

It is advantageous when the shielding nose is arranged next to an outgoing filament line, near the base, of the illuminant remote from the base. Consequently, the filament remote from the base can have the function of a passing beam or the function of a high beam without preventing a high light yield through the incandescent filament near the base.

It is preferred when the illuminants are incandescent filaments such that the present invention can be applied to halogen incandescent lamps, for example.

When the reflector is a paraboloid, a homogeneous light distribution can be implemented in conjunction with little dazzling of the oncoming traffic through support by the anti-dazzle device.

It is preferred, furthermore, that an axis that connects the central axis of the illuminant, remote from the base, and the center of the reflector cutout runs through a shielding nose of the shield device. It is possible in this way to implement a clearly delimited shielded sector of large area on the reflector inner surface, and to optimize said sector with reference to an illuminant near the base.

### BRIEF DESCRIPTION OF THE DRAWINGS

The aim below is to explain the invention in more detail with the aid of an exemplary embodiment. In the figures:

FIG. 1 shows a halogen incandescent lamp in the case of which the shield device of the present invention can be used,

FIG. 2 shows a shield device corresponding to the present invention with incandescent filaments and reflector cutout, and

FIG. 3 shows a plan view of a headlight reflector with illustrated boundaries of the shielded sectors in the case of the use of an inventive shield device.

### PREFERRED DESIGN OF THE INVENTION

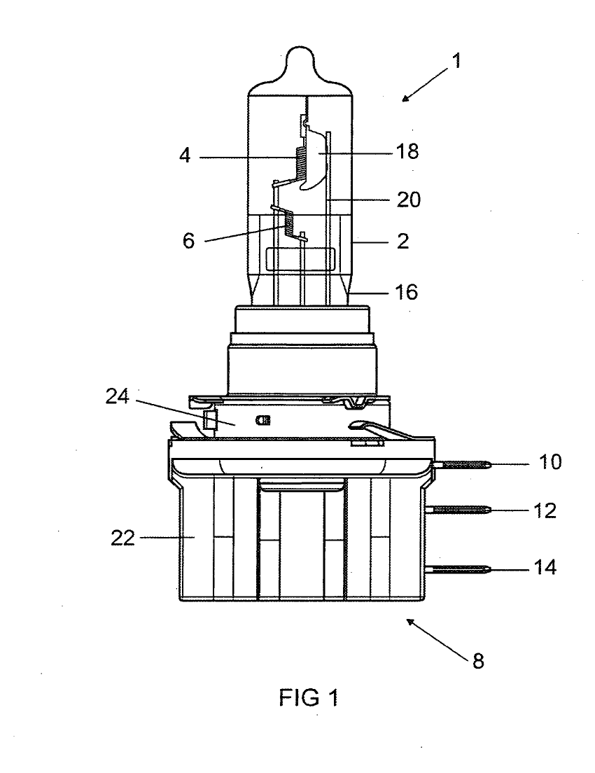

FIG. 1 shows a halogen incandescent lamp 1 for a vehicle headlight, in the case of which the inventive shield device can be used.

This halogen incandescent lamp 1 has a vitreous, substantially cylindrical lamp vessel 2 in whose interior two incandescent filaments 4, 6 are arranged that are aligned parallel to the lamp vessel axis and can serve, for example, to generate a high beam or a daylight running light or a high beam and a passing beam. The incandescent filaments 4, 6 are designed, for example, as single or double coiled tungsten wires, and a voltage can be applied to them via contact lugs 10, 12, 14 guided through a lamp base 8. The sealed end 16 of the lamp vessel 2 is anchored in the lamp base 8. The incandescent filament 4 remote from the base is partially surrounded by an anti-dazzle device 18 formed from molybdenum plate. This anti-dazzle device 18 is supported by a supply lead 20 of the three supply leads shown in FIG. 1.

Provided on the base 8 of the halogen incandescent lamp 1 next to a plastic base part 22 in which the contact lugs 10, 12, 14 are embedded is a metal sleeve 24 whose outside diameter constitutes the minimum dimension for a cutout 26 in a reflector 28 in which the halogen incandescent lamp can be arranged.

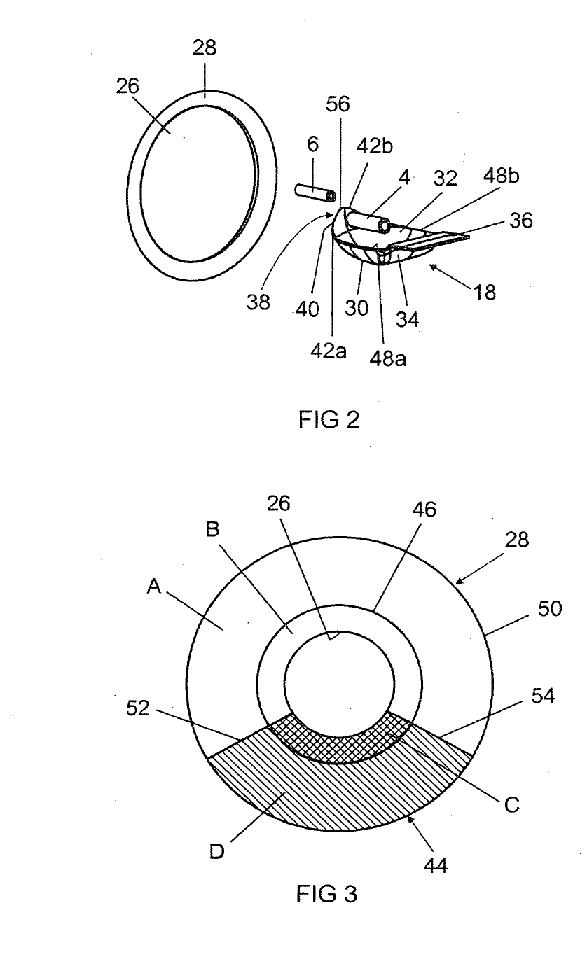

FIG. 2 shows an enlarged illustration of the anti-dazzle device 18, the filament 4 remote from the base, the filament 6 near the base, and the cutout 26 in the reflector 28. Remaining components of the reflector and of the incandescent lamp have been left out in order to improve clarity.

The configuration of the inventive shield device is described below with the aid of the anti-dazzle device 18 from FIG. 2.

The anti-dazzle device 18 shown in FIG. 2 is of trough-type design; it has an essentially flat bottom 30 that is delimited by a wall portion 32. A welding lug 36 is integrally formed on a flattened part 34 of the wall section 32, and the cap region 38, situated opposite the welding lug 36, of the anti-dazzle device 18 is drawn upwards by comparison with the remaining wall portions 32 and forms a shielding nose 40. This shielding nose shields from one another the incandescent filament 4 remote from the base and the incandescent filament 6 near the base.

Furthermore, FIG. 2 illustrates the relative position of the reflector cutout 26 of the reflectors 28 in relation to the incandescent filaments 4, 6 and to the anti-dazzle device 18. The surface active for the shielding of the incandescent filament 4 remote from the lamp is formed by the bottom 30 and the curved wall portions 32 of the anti-dazzle device 18 including the shielding nose 40. The anti-dazzle device 18 has mirror symmetry with a mirror plane that runs perpendicular to the bottom 30 and extends in the longitudinal direction through the anti-dazzle device 18.

The shielding nose 40 has two shielding edges 42a, 42b that run up to the abovenamed mirror plane, and whose spacing increases from the bottom 30 to the mirror plane. The spacing of the edges 48a, 48b of the wall portion 32 from the bottom 30 is constant up to the shielding nose 40.

Whereas in the case of the H4 lamp according to the prior art the installed anti-dazzle device also serves to provide the light/dark boundary, a shielded sector 44 shown in FIG. 3 is formed with the aid of the anti-dazzle device 18 of the present invention. FIG. 3 shows the plan view of a reflector from its side with the largest diameter in a plane that runs parallel to the plane of the reflector cutout. The mark 46 in the shape of a circle shows by way of example the appearance of the reflector cutout in accordance with the prior art, for example of the H4 lamp. The diameter of the reflector cutout is 38.2 mm, for example. By comparison therewith, the reflector cutout 26 in accordance with the present invention has a smaller diameter, for example the diameter of the reflector cutout is in the region of 10 mm and less than 30.2 mm.

The shielded sector 44 and the mark 46 subdivide the reflector inner surface in the plan view on FIG. 3 into a radially outer sector A, a radially inner sector B, an inner shielded sector C and an outer shielded sector D. The shielded sector C extends from the reflector cutout 26 to the mark 46. The shielded sector D extends from the mark 46 up to the circumferential portion 50, which constitutes the largest circumference of the inner surface of the reflector.

The shielding edges 42a, 42b of the anti-dazzle device 18 have the effect of producing boundaries 52, 54 of the shielded sectors C, D during operation of the illuminant 4 remote from the base. These boundaries have rectilinear shape and preferably run from the center of the reflector cutout 26 in the radial direction to the circumferential portion 50. In this case, the shielded region is formed by the edges 42a, 42b and by the outer edge 48 starting from the vertex 56 of the anti-dazzle device 18.

The effect of the inventive configuration of the anti-dazzle device 18, in particular of the shielding nose 40 with the shielding edges 42a, 42b, and of the outer edge 48a, 48b is to prevent the sector C from being illuminated by the incandescent filament 4 remote from the base. Subsequently, the useful light for the incandescent filament 6 near the base can be increased such that the reflector manufacturer can optimize the sector C for the filament 6 near the base. As a result, it is possible to prevent the sector C from being illuminated by the incandescent filament 4 remote from the base and to prevent scattered light and increased dazzling of oncoming vehicles.

The rectilinear course, shown in FIG. 3, of the boundaries is also obtained by virtue of the fact that the outer edges 48a, 48b of the anti-dazzle device 18 run parallel to the central axis of the incandescent filament 4. For example, the anti-dazzle device 18 has a maximum width in the range from 5 mm up to 12 mm. It is preferred that the vertex 56 of the shielding nose 40 lies at such a height that an axis on which the center of the reflector cutout 26 and the central axis of the incandescent filament 4 remote from the base are located runs through the shielding nose 40.

The relative arrangement between the shielding nose 40 and incandescent filament 4 remote from the base is selected in such a way that the shielding nose 40 is located between the outgoing filament line, remote from the base, of the incandescent filament 6 near the base and the outgoing filament line, near the base, of the incandescent filament 4 remote from the base. In this way, the anti-dazzle device in accordance with the present invention has, on the one hand, the function that the direct beam between the incandescent filament 4 and the incandescent filament 6 is shielded and, on the other, the function that shielding outside the inner circumference of the reflector cutout 26 preferably takes place in the form of the straight line of the boundaries 52, 54.

The shielded sector 44 can form an angle in the range from 120° up to 165°. As a result, this shielded sector 44 can be optimized for the incandescent filament 6 near the base.

The inventive configuration can advantageously be used by daylight running lamps, in the case of which the anti-dazzle device does not have the function of the light-dark boundary. By means of the invention, it is possible to obtain more useful light from the filament near the base, there is less dazzling of the oncoming traffic, the light distribution is more homogeneous, and a more effective design of the reflector can be undertaken.

A shield device for a headlight lamp is provided and comprises a reflector which has a reflector cutout of smaller diameter than 38.2 mm, and two illuminants. The shield device is configured in such a way that, when viewed from a plane parallel to the reflector cutout, at least one boundary of the sector, which is near the cutout, shielded by the shield device on the reflector, and located between the reflector cutout and a circumscribed circle about the reflector cutout with a diameter of 38.2 mm, lies on a straight line.

1. A shield device (18) for a headlight lamp that is seated in a reflector (28), which has a reflector cutout (26) of smaller diameter than 38.2 mm, and that has two illuminants (4, 6), the shield device being configured in such a way that, when viewed from a plane parallel to the reflector cutout (26), at least one boundary (52, 54) of the sector (C), which is near the cutout, shielded by the shield device on the reflector, and located between the reflector cutout (26) and a circumscribed circle (46) about the reflector cutout with a diameter of 38.2 mm, lies on a straight line.

2. The shield device as claimed in claim 1, in which the shield device is configured in such a way that, when viewed from a plane parallel to the reflector cutout, at least one boundary (52, 54) of the sector (C, D), which is shielded by the shield device on the reflector (28) and located between the reflector cutout (26) and the outer circumference (50) of the reflector, lies on a straight line.

3. The shield device as claimed in claim 1 or 2, in which, when viewed from a plane parallel to the reflector cutout, both boundaries (52, 54) of the shielded sector (44) lie on a straight line.

4. The shield device as claimed in claim 1, in which the straight line cuts the center of the reflector cutout (26).

5. The shield device as claimed in claim 1, in which the shielded sector (44) lies in an angle range of substantially 120° to 165°.

6. The shield device as claimed in claim 1, in which the shield device has a shielding nose (40) whose edges (42a, 42b) form the boundary for the shielded sector.

7. The shield device as claimed claim 6, in which a location inside the reflector cutout (26) can be shielded by the vertex edge (56) of the shielding nose.

8. The shield device as claimed in claim 1, in which the greatest width of the shield device is in the range from approximately 5 mm up to approximately 12 mm.

9. The shield device as claimed in claim 1, having a reflector (28) and two illuminants (4, 6) arranged in the reflector interior.

10. The shield device as claimed in claim 9, in which the shield device is arranged in such a way that said shield device does not effect any shielding of the reflector (28) with reference to an illuminant (4, 6) provided in the reflector.

11. The shield device as claimed in claim 9 or 10, in which the diameter of the reflector cutout (26) is in the range from 10 mm to less than 38.2 mm.

12. The shield device as claimed in claim 9, in which the two illuminants are respectively illuminants (6, 4) that are near the base and remote from the base and which can be shielded from one another by a shielding nose (40) of the shield device.

13. The shield device as claimed in claim 12, in which the shielding nose (40) is arranged next to an outgoing filament line, near the base, of the illuminant (4) remote from the base.

14. The shield device as claimed in claim 9, in which the illuminants (4, 6) are incandescent filaments.

15. The shield device as claimed in claim 9, in which the reflector (28) is a paraboloid.

16. The shield device as claimed in claim 9, in which an axis that connects the central axis of the illuminant (4), remote from the base, and the center of the reflector cutout (26) runs through a shielding nose (40) of the shield device.

17. A lamp having a shield device as claimed in claim 1.

18. A vehicle headlight having a lamp as claimed in claim 17.
